(19) United States
(12) Patent Application Publication
(10) Pub. No.: US 2007/0040443 A1
(43) Pub. Date: Feb. 22, 2007

(54) Tubeless tire with combined wheel rim

(75) Inventor: Chun-Feng Chen, Taichung Hsien (TW)

Correspondence Address: TROXELL LAW OFFICE PLLC, SUITE 1404, 5205 LEESBURG PIKE, FALLS CHURCH, VA, 22041, US

(73) Assignee: Ourway Engineering Co., Ltd.

(21) Appl. No.: 11/335,521

(22) Filed: Jan. 20, 2006

(30) Foreign Application Priority Data
Aug. 16, 2005 (TW) 94213988

(51) Int. Cl. B60B 3/10

(52) U.S. Cl. 301/64.303

(57) ABSTRACT

A tubeless tire with combined wheel rim, wherein, left half wheel rim is locked with right half wheel rim to make an integrative wheel rim, inner rim of tubeless tire is gap shape and cover onto circular groove of wheel rim of tubeless tire, its features are as follows: to thicken side wall of tubeless tire properly, cover a [symbol] -shaped section support ring onto open end of inner rim. When cover tubeless tire and support ring onto left half wheel rim, then lock up into a complete wheel rim with right half wheel rim, and position inner rim of tubeless tire into the formed circular groove, as fill air into tubeless tire, tire can keep more close with wheel rim.

### BACKGROUND OF THE INVENTION

1) Field of the Invention

This invention relates to tubeless tire with combined wheel rim, which can let wheel rim and tubeless tire keep closer as combined.

2) Description of the Prior Art

According to the current invention, tubeless tire with combined wheel rim, as shown in FIG. 1 and FIG. 2, wheel rim 2 is combined with left half wheel rim 21 and right half wheel rim 22, inner rim 31 of tubeless tire 3 is gap shape 32; collar flange 211 is set at outside of left half wheel rim 21, its central part is of round plane 212, and first cover inner rim 31 about half thickness of tubeless tire 3 onto it, round plane 213 is set at its furthest inside, several holes 214 are set on round place 213, collar flange 221 is set at outside of right half wheel rim opposite to left half wheel rim, its central part is round plane 222, and cover another inner rim 31 about half thickness of tubeless tire 3 onto it, round plane 223 is made in furthest inside of right half wheel rim 22, holes 224 are set on round plane 223 opposite to round plane 213 of left half wheel rim 21, finally, fasten bolts (not draw herein) through holes 214,224 with nuts (not draw herein) so as to make a complete wheel rim 2 with left half wheel rim 21 and right half wheel rim 22, circular groove 23 (as shown in FIG. 2) at outside of wheel rim 2 combined with outside collar flange 211 & central round plane 212 of left half wheel rim 21 and outside collar flange 221 & central round plane 222, so that tubeless tire 3 is embedded and fixed into circular groove 23, therefore, as fill air into tubeless tire 3, air pressure may make its outside of inner rim 3 land inner wall 2111 of outside collar flange 211 of left half wheel rim 21, inner wall 2211 of outside collar flange 221 of right half wheel rim 22 be close and sealed.

However, if above described tubeless tire 3 is accidentally pierced by something, part of air will leak out from where pierced, so, air filled into tire may reduce accordingly, moreover, weight loading on this tubeless tire (for example, this type of tubeless tire is applied to wheelchair or garbage truck) will change shape of tire towards wheel rim 2, outside 33 of its inner rim 31 can not keep close and seal with inner wall 2111 of outside collar flange 211 of left half wheel rim 21, inner wall 2211 of outside collar flange 221 of right half wheel rim 22 resulting air to leak from this point, so, tubeless tire 3 may have no air at last. Therefore, such tire is required to get improved.

### SUMMARY OF THE INVENTION

This invention has improved disadvantage of above said structure, its main purpose is to provide a tubeless tire with combined wheel rim, wherein left half wheel rim is locked with right half wheel rim to make an integrative wheel rim, the inner rim of tubeless tire is gap-shaped. Thicken side wall of tubeless tire properly, cover a [symbol] -shaped section support ring onto open end of inner rim. When cover tubeless tire and support ring onto left half wheel rim (or right half wheel rim), then lock up into a complete wheel rim with right half wheel rim (or left wheel rim), and position inner rim of tubeless tire into the formed circular groove, as fill air into tubeless tire, tire can keep more close with wheel rim.

### BRIEF DESCRIPTION OF THE DRAWINGS

FIG. 1 is the exploded view of structure of the prior art.

FIG. 2 is the plane sketch map combining with wheel rim in the prior art.

FIG. 3 is the exploded view of this invention.

FIG. 3-A is the exploded appearance view of left wheel rim from another angle in this invention.

FIG. 4 is the exploded combination appearance view of this invention.

FIG. 5 is the combination section sketch map of this invention.

FIG. 6 is the combination section embodiment sketch map of this invention.

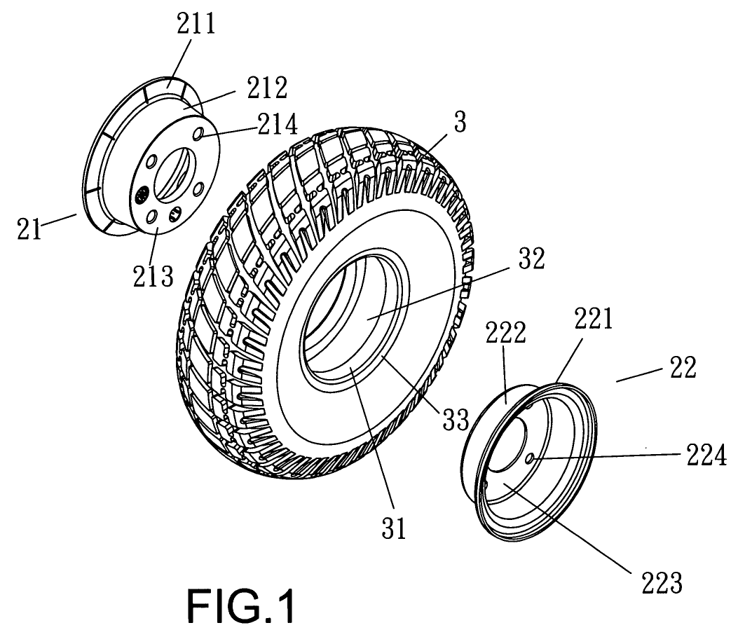

### DETAILED DESCRIPTION OF THE PREFERRED EMBODIMENTS

For your better reference, we hereby specially provide features and operation of this invention with descriptions of figure in the following.

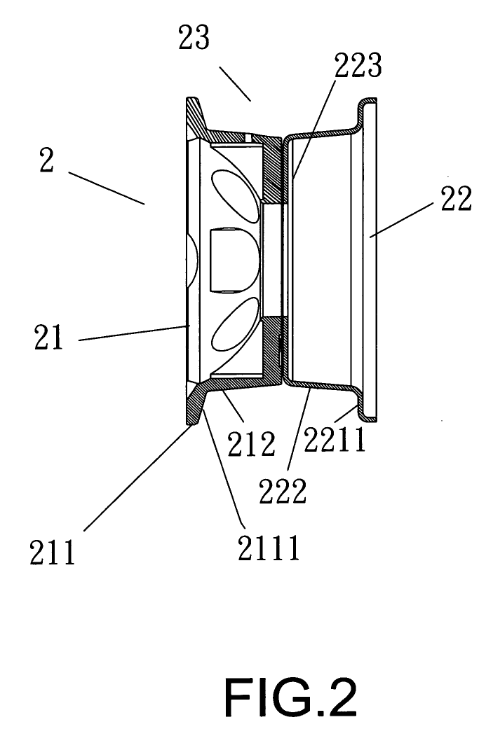

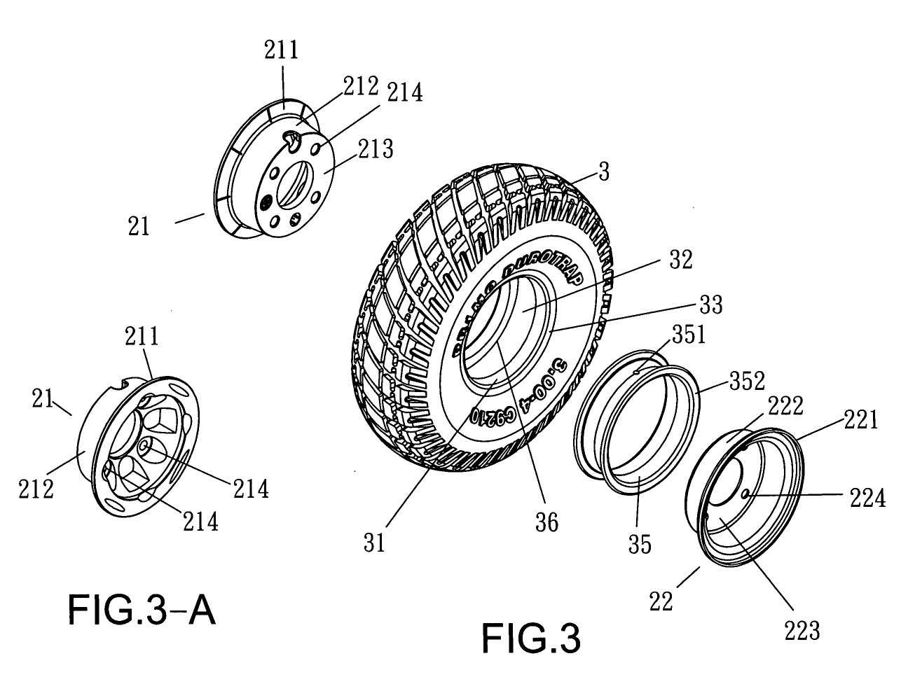

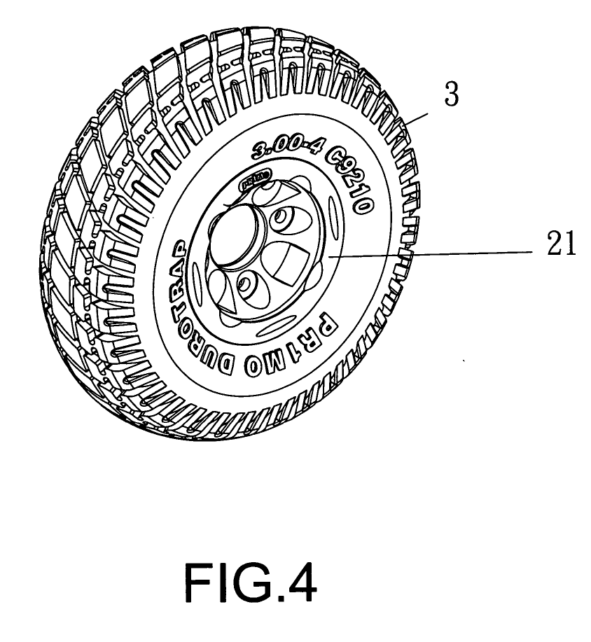

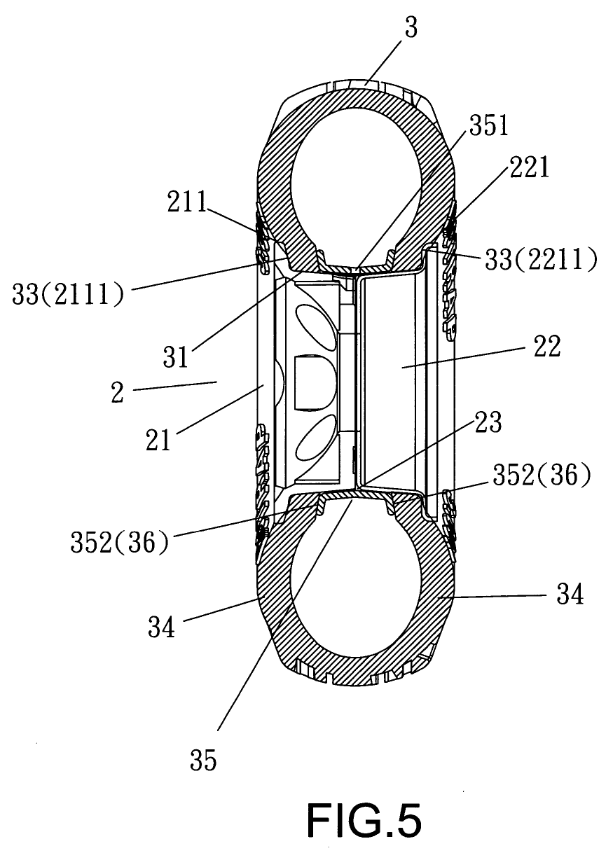

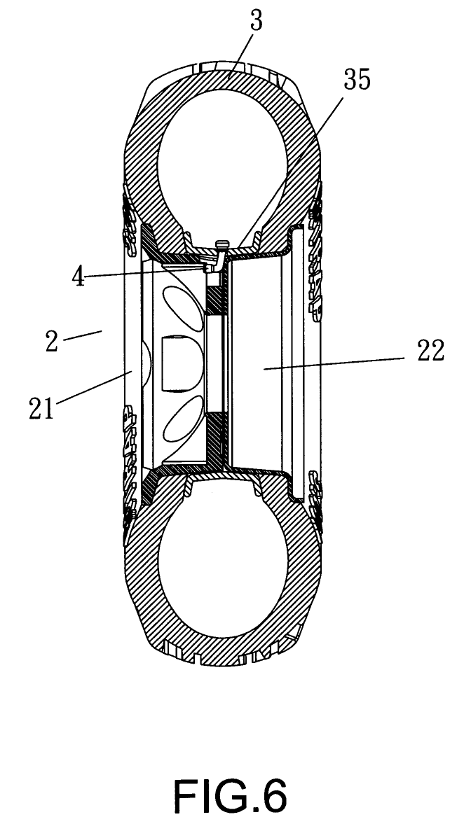

Please refer to FIG. 3, FIG. 3-A, FIG. 4, FIG. 5 and FIG. 6, this invention is composed of an integrative wheel rim 2 combined with left half wheel rim 221 and right half wheel rim 22, gap-shaped inner rim of tubeless tire in central part; collar flange 211 is set at outside of left half wheel rim 21, its central part is round plane 212, where inner rim 31 about half thickness of tubeless tire 3 can cover onto it, a round plane 213 is set at its furthest inside, and several holes 214 are made on round plane 213; and collar flange 221 is also set at outside of right half wheel rim 22 opposite to left half wheel rim 21, its central part is round plane 222, where inner rim 31 about half thickness of tubeless tire 3 can cover onto it, round plane 223 is set at its furthest inside, several holes 224 are made on round plane 223 opposite to holes 214 on round plane 213 of left half wheel rim 21, finally, lock left and right half wheel rim with bolts and nuts passing through holes 214, 224 so as to comprise a complete wheel rim 2, therefore, circular groove 23 (as shown in FIG. 2) can be formed at outside of wheel rim 2 combining with outside collar flange 212 and central round plane 212 of left half wheel rim, collar flange 221 and central ring plane 222 of right half wheel rim, so that tubeless tire 3 is embedded and fixed into circular groove 23.

Features of this invention are as follows: thicken sides wall 34 of tubeless tire 3 properly, cover the central gap-shape 32 of inner rim 31 onto one of its upper hole 351 and form [symbol] -shaped section support ring 35, connect hole 351 with rim valve 4 for filling air (as shown in FIG. 6) so as to cover tubeless tire 3 with half thickness and support ring 35 onto central ring plane 212 of left half wheel rim 21, tubeless tire with another half thickness and support ring 35 onto round plane 222 of right half wheel rim 22, finally lock up into a complete wheel rim with left half wheel rim 21 and right half wheel rim 22 in opposite, and inner rim 31 of tubeless tire 3 is embedded into circular groove 23.

When fill air into tubeless tire from rim valve 4 for wheel of wheel chair or garbage truck so as to bear load of these articles, air pressure can not only let outside 33 of inner rim 31 keep close with side wall 2111 of collar flange 211 at outside of left half wheel rim, side wall 2211 of collar flange 221 at outside of right half wheel rim, but also inside 36 of inner rim 31 of tubeless tire 3 can press towards two circular outside walls 352 with [symbol] -shaped section support ring 35 so as to make another layer of close seal, tubeless tire 3 can keep more close with wheel rim 2.

Further more, even if surface of tubeless tire 3 is pierced by something, only few of air may leak out from where pierced, however, most of air inside may still be preserved in tubeless tire 3, it is not easy to distort in direction of wheel rim 2 owing to inside 36 of inner rim 31, because sides wall 34 of tubeless tire 3 are properly thickened, its inside 35 may press towards circular outside wall 352 of [symbol] -shaped section support ring 34 to keep close and seal, so that inside of tubeless tire 3 can maintain a long time air-filling state, then, you can further drive a while before get it fixed.

What is claimed is:

1. A tubeless tire with combined wheel rim, which is composed of an integrative wheel rim combined with left half wheel rim and right half wheel rim, gap-shaped inner rim of tubeless tire in central part; wherein, collar flange is set at outside of left half wheel rim, its central part is circular plane, its inside is round plane, several holes are set on it; collar flange and round plane in central part are set on right half wheel rim opposite to left half wheel rim, round plane is also set at its furthest inside, holes also made at where are opposite to holes in its round plane and round plane of left half wheel rim. Finally, lock left and right half wheel rim with bolts and nuts passing through holes so as to comprise a complete wheel rim, therefore, a circular groove can be formed at outside of wheel rim by combining with outside collar flange and central round plane of left half wheel rim, collar flange and central circular plane of right half wheel rim, so that tubeless tire is embedded and fixed into circular groove.
Its feature is as follows: to cover [symbol] -shaped section support ring with hole onto it in the central gap-shaped inner rim of tubeless tire.

2. As claimed in claim 1, it is tubeless tire with combined wheel rim, wherein side wall of tire can properly be thickened.

3. As claimed in claim 1, it is tubeless tire with combined wheel rim, wherein hole in [symbol] -shaped section support ring can connected with rim valve.
